(19) United States
(12) Patent Application Publication
(10) Pub. No.: US 2012/0280893 A1
(43) Pub. Date: Nov. 8, 2012

(54) FREE-HORIZON BINOCULAR IMAGE DISPLAY DEVICE WITH INTEGRATED VIDEO SIGNAL SOURCE

(75) Inventor: László Holakovszky, Halasztelek (HU)

(73) Assignees: Sándor Lörincz, Székesfehérvár (HU); László Holakovszky, Halásztelek (HU)

(21) Appl. No.: 13/508,121

(22) PCT Filed: Nov. 4, 2010
(86) PCT No.: PCT/HU10/00118

§ 371 Date: Jul. 19, 2012

(30) Foreign Application Priority Data
Nov. 5, 2009 (HU) P0900696

(51) Int. Cl. G09G 5/00

(52) U.S. Cl. 345/8

(57) ABSTRACT

A binocular display device comprises a head-mounted supporting frame and two image display blocks arranged below eye level, said blocks comprising a display and a magnifying optical system. The device further comprises a case arranged above eye level, a transversal console arranged below eye level, said consol projecting from the central plane of the head, wherein said blocks are fixed to the end portions of the console, a bridging element adapted to rigidly connect a bottom central part of the case to a central part of the console, said bridging element being arranged between the eyes and extending immediately adjacent the head and leaning, at its lower end, directly or indirectly against the nose ridge. The device further comprises a video signal source arranged in the case, and a plurality of wires extending from the video signal source through the bridging element and the console to the displays.

### BACKGROUND OF THE INVENTION

1. Field of the Invention

The present invention relates to a head-mounted binocular image display device with an integrated video signal source.

2. Description of the Related Art

The head-mounted displays (HMD) are widely known in the art. Most of the known devices present the virtual image at the level of eyes, in the middle of the field of view. However, this disturbs viewing and also hinders the mobile use. To partly avoid such deficiencies, there have been proposed monocular solutions, wherein there is a display block or element only in front of one eye. These solutions have the disadvantage that while one of the eyes is watching the virtual image, the other eye sees the surrounding environment in the same direction, causing an interference between the two eyes. There also exist devices that comprise a semitransparent optical elements in front of the eyes, wherein the environment can be seen through the virtual image. Such solutions have the drawback that the two kinds of image are superposed and thus interefere. Upon recognizing the above problems, majority of the binocular devices in the market (e.g. Vuzix iWear AV920, ezVision G1 Video Glasses, Icuiti DV920, MyVu Personal Media Viewer, ITG Vidix, Mobintech Personal Display Glasses, Shenzen W. Rider RD-E202, etc.) comprises the image display blocks in a slim case at the level of eyes, below and above which one can see the environment. Such a slim case, however, masks the part of the field of view that is most important with respect to observation, or even the whole horizon of the user. Another problem is that the majority of the known HMD's are connected to the video source, such as a portable video player or pocket computer, through an swing wire, which is not a compact design because a separate image source should be carried on, to which the swing wire is to be connected, and after use, the swing wire should be wounded and packaged. In order to provide a compact design without swing wire, the image source, e.g. a computer, should also be integrated into the HMD. If these tools are built in the case arranged in front of the eyes, the problem of blocking the front view by the case will remain or even increase. If said tools are, however, built in the stems of a glasses-type device, its stems will be unnecessarily thick and inflexible, and wires should be led through the hinged stems, which introduces the risk of wire breaking. Furthermore, such a device is difficult to wear together with his own glasses of the viewer.

It is an object of the present invention to provide a binocular device of the compact type presenting a high-contrast image and comprising a pair of flexible stems for mounting onto the head, said device further comprising a video signal source, like a computer, arranged in a central part of the device in front of the head, while leaving the horizon entirely free.

### SUMMARY OF THE INVENTION

According to the inventive idea, the above objects are achieved by arranging the image generation elements of the device rather below and above the level of the eye than in front of the eyes, and the bridging element is arranged invisible for the eyes. To this end, the video signal source is accommodated in a horizontal flat visor-like case above the level of eye, preferably at the level of eye brow or in front of the forehead, whereas the image display block are mounted to the two ends of the bottom side of a transversal console arranged below the level of eye. The transversal console and the visor-like case are connected by a narrow bridging element extending immediately in front of the head, between the two eyes, said bridging element also having a support leaning against the nose ridge, and being formed integrally with the transversal console. Inside the bridging element, wires are accommodated.

The image display block comprises an emission-type or transilluminated microdisplay, as well as a magnifying optical system, which may include any kind of known solution, such as lupe, catadioptrics system, free-form prism, etc.

According to a further inventive idea, a catadioptrics system, being well known itself, which comprises a concave reflective surface and a light distribution element, can be adapted to provide a sharp image for a user having any interpupillary distance only if along the light path extending from the screen of the display to the pupil, there are inserted additional spherical or aspherical correction surfaces to reduce image generation errors.

The visor-like case can be seen as an edge for an external observer, or more particularly, other persons having the same height as that of the user can see only a narrow rim surface thereof. Consequently, the case does not cover the head, it seems to be light-weight and airy, which is of high importance for a device worn on the head among people. The wires connecting the displays and the video signal source do not traverse movable hinges, thus eliminating the risk of wire breaking. All of the components of the video signal source, including a microprocessor, a memory, a display driver, an accumulator, an optional receiver, etc. may be integrated into a single integrated circuit arranged within said visor-like case, resulting in a compact and cheap product. The operating elements, e.g. push buttons, may preferably be arranged on the upper surface of the visor-like case. Any one of the push buttons can be pushed by using one's index finger or middle finger while supporting the bottom of the visor-like case by one's thumb, thereby it can be avoided that the image jumps within the field of view of the user at a pushing action, as it has been experienced with other solutions.

### BRIEF DESCRIPTION OF THE DRAWINGS

FIG. 1 is a perspective view of a preferred embodiment of the binocular image display device according to the invention.

FIG. 2 illustrates the device shown in FIG. 1 when mounted onto the head of a user.

FIG. 3 is a side view of the device shown in FIG. 1, with illustrating the image display block of the left eye in a cross-sectional view.

FIG. 4 is a schematic top plan view of the visor-like case of the device, with illustrating a possible arrangement of the operating elements.

### DESCRIPTION OF THE PREFERRED EMBODIMENTS

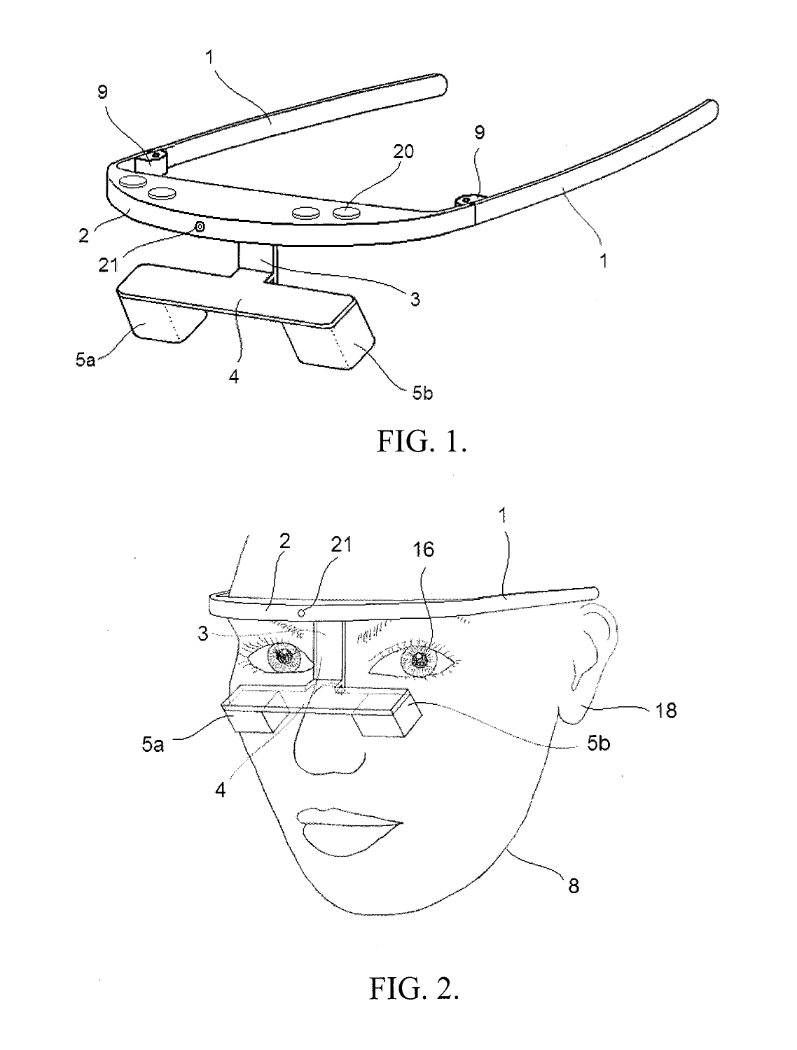

As shown in FIGS. 1, 2 and 3, the binocular image display device according to the invention basically comprises a pair of clamping stems 1, a case 2, preferably a flat visor-like case as shown in the drawings, a bridging element 3, a transversal console 4, two image display blocks 5a, 5b, a video signal source 6 arranged in the case 2 and a plurality of wires 7, preferably foil wires, extending from the video signal source 6 through the bridging element 3 and the transversal console 4 to the image display blocks 5a, 5b. It is preferred that the stems 1 are made of flexible plastics by injection moulding and have such a thickness and such a cross-section that in their opened state, when clamped onto the head 8 of a user, they hold the device securely, but without exerting an excessive clamping force thereto, while they distribute the weight of the device to both sides of the head, thereby partly reducing the load on the nose ridge, which is, in fact, rather pressure-sensitive. The stems 1 both comprise a hinge 9 conventionally used in glasses. The visor-like case 2 comprises the video signal source 6, which includes a microprocessor and its utility circuit components, a memory, a power supply and a microdisplay driver, all of these components preferably being integrated into a single chip, and optionally, a radio frequency receiver, e.g. Bluetooth or Wi-Fi connection circuit, a TV tuner, a video camera 21, a microphone or any other elements. In the illustrated embodiment, the visor-like case 2 is made of two thin injection moulded plastic halves, wherein the upper half and the section of each stem 1 extending to the hinge 9 are formed as one piece. The bridging element 3 projects from the middle of the lower half and extends downward adjacent to the head 8. The bridging element 3 is formed as a rigid stripe-like plate that during its wearing, is positioned close to the head 8, thus the field of view for either eye 16 is covered only to a negligible extent. The wires 7 are led inside the bridging element 3, for example, within its injection moulded body, preferably in the form of foil wires. The lower end portion of the bridging element 3 has an arcuate surface corresponding to the shape of the nose ridge, or it is attached to the nose ridge by means of a raising member 19. The transversal console 4 is coupled to the outer side (i.e. the side opposite to the head 8) of the lower part of the bridging element 3, and for stability reasons, it is formed as one piece therewith. The entire transversal console 4 is positioned below the level of eye 17 of the user to provide a free horizontal view. Said two image display blocks 5a, 5b are fixed to the end portions of the bottom side of the transversal console 4. Between the bridging element 3 and the image display blocks 5a, 6b, the wires 7 are led inside the transversal console 4, preferably within its injection moulded body.

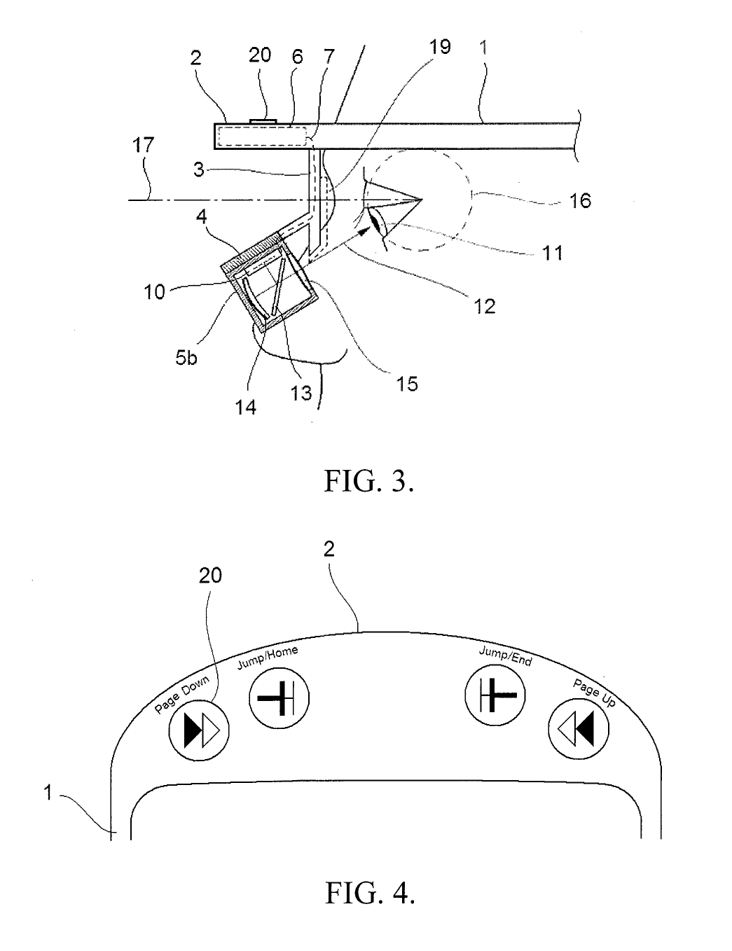

As shown in FIG. 3, the displays 10, such as microdisplays, and the associated optical elements adapted for magnifying the screen of said displays are arranged inside the image display blocks 5a, 5b. Instead of the well-known combination of a simple concave mirror and a semitransparent mirror, in the illustrated embodiment according to the invention, a novel solution providing a high IPD range is preferably used. Along the light path extending from the display 10 to the pupil 11, the light beams 12 emitted from the display 10 are first reflected from a beam splitter plate 13 at an angle of 90 degrees, traverse a first spherical or aspherical surface of a meniscus lens 14, then reflect from a mirroring coat applied to a second convex spherical or aspherical surface of said meniscus lens 14. After reflection, the light beams 12 traverse said first surface and said beam splitter plate 13 again, and then also traverse two spherical or aspherical surfaces of a correction lens 15. Along their path, the light beams reach five spherical or aspherical surfaces altogether, the surfaces of which are optimized by a computer design process so that the eye motion box (i.e. the motion range of a pupil viewing an image with no disturbing image generation errors) covers at least 95% of the statistical IPD range (59 to 71 mm) of the woman and man population elder than 10 years. A vertical extension of the eye motion box so as to provide an even free view, however, is to be avoided, and thus because of the various nose ridge heights of the users, a vertical adjustment of the image display blocks 5a, 5b should be allowed in order to position them in front of the eyes, which can be carried out by an adjustment or a replacement of said raising member 19.

FIG. 4 illustrates the operating elements of the examplary embodiment. By means of four push-buttons 20, in particular by pressing any one of them for either short or long time, or pressing the in combination, the video signal source 6 can be simply controlled, which is suitable for sequential memory contents, such as book pages, pictures and video clips. When a memory with substantial capacity (in the order of Gigabytes) is used, video clips and even movies can be stored in the memory. A design including a minimum number of push buttons has the advantage that their manipulation can be learned quickly, and thereafter the device may be operated “blindly” as well. Due to its own operating elements, the device becomes a stand-alone consumer electronic and information technology device, and one may use it, for example as a virtual e-book or a pair of movie glasses, while going to school or work on public transportation vehicles one or two hours a day, allowing the user to read, to learn or to entertain in a “manually free” manner. In case the device is to be used as a fully functioning personal computer, a complete alphanumerical keyboard is also needed. For this purpose, a private smart phone (i.e. programmable mobile phone with touch-screen) may be adapted by means of a special software that when a push-button is pushed down or a specific area of the touch-screen is contacted, transmits a code of the push-button or the contacted area of the touch-screen through a radio frequency interconnection to the receiver integrated into the case 2, thereby allowing to control the microprocessor. By drawing one's finger on the touch-screen of the smart phone in a way like on a touch pad, a cursor may be moved on the virtual image or one can click by rapping thereon, which allows for the user to operate on files, to edit text or to use a menu system. The use of a receiver also allows that if the small display size of the mobile phone (having a display diagonal of at most 10 cm due to its pocket size) is not satisfactory, the image shown by the mobile phone may also be presented as a remote virtual image, such as an e-mail, an internet web page, a Youtube videoclip, a game, a digital TV broadcast or a downloaded movie, on the large, high-resolution display of the head mounted device. To this end, a software adapted to transmit the image to the receiver of the head- mounted device through a radio frequency channel in real time should be implemented on the mobile phone.

As shown in FIG. 1, a miniature video camera 21 may also be arranged in the case 2, preferably as integrated into the chip including said microprocessor, which further enhances functionality of the device. When a two-dimensional pattern with known dimensions is placed into the field of view of the video camera 21 (for example, onto the top surface of a table), which pattern is recognized by the microprocessor using a high-speed image processing software, the spatial position and orientation of the camera can be determined from the perspective distortions of said pattern, and a three-dimensional model stored in the memory may be displayed by using the actual camera direction. Thereby the 3D model can be viewed around even by 360 degrees. Such an application may be of great importance, inter alia, in the field of industrial design, architectural planning, engineering planning. Further applications include the spatial replacement of the body of a patient lying on a surgical table with a 3D model built up from a plurality of image layers previously recorded by means of any medical image generation method (e.g. CT, PET, MRI), making the patient “transparent” for the surgeon from the direction of the virtual image. By using such a method, the vascular system, the bone system, the innards, etc. of a patient can be visualized at the real place of the patient, and the spatial position of the examined pathological disease can easily be recognized At the advanced laparoscopic and endoscopic operations, this facilitates determination of the ideal penetration points and directions, and at tissue sampling, it also facilitates the biopsy pointing. As the device is wireless, it does not hinder motion of the surgeon in the operating room, and due to his free horizon, the surgeon is not blocked to sense his environment. In addition to the 3D model, the memory may also store a complete anamnesis of the patient, and the control unit arranged in the case 2 can maintain a continuous wireless connection with a hospital computer information system and when a microphone is built in the case 2, it can also display, through voice control, all actual information that may be interesting to the surgeon (e.g. EKG or other life function signals).

The device may further comprise ear canal loudspeakers, wherein the audio signals can be conveyed from a connector of the case 2 comprising the audio signal source to the ears by swing wires.

The device may also be adapted for displaying 3D images. To this end, in a manner known itself, different images are displayed by the left and right image display blocks 5a, 5b according to the different viewing angles of the eyes 16.

The binocular image display device according to the invention is not limited to its preferred embodiment described above, but many modifications thereof can be carried out within the scope of the invention defined by the attached claims.

1-9. (canceled)

10. A binocular display device with an integrated video signal source, wherein said device comprises a head-mounted supporting frame and two image display blocks arranged below the level of eye, said image display blocks comprising a display and and a magnifying optical system, characterized in that the device further comprises
a case arranged above the level of eye, preferably at the level of the eyebrows or in front of the forehead,
a transversal console arranged below the level of eye, said transversal consol laterally projecting from the central plane of the head into both directions, wherein said two image display blocks are fixed to the end portions of the transversal console,
a bridging element adapted to rigidly connect a bottom central part of the case to a central part of the transversal console, said bridging element being arranged between the two eyes and extending immediately adjacent to the head and leaning, at its lower end, directly or indirectly against the nose ridge,
a video signal source arranged in the case, and
a plurality of wires extending from the video signal source through the bridging element and the transversal console to the displays accommodated in the image display blocks.

11. The device according to claim 10, wherein the video signal source comprises a processor, a memory, a current source, a microdisplay driver circuit, a power supply, electronic operating elements and connectors.

12. The device according to claim 10, wherein the video signal source comprises any one of the following components: radio frequency receiver, infrared receiver, video camera, microphone, accumulator charger circuit, audio circuit, TV tuner, GPS module and GSM module.

13. The device according to claim 12, wherein the case comprises any one of the following components: earphone connector(s), USB port, serial port, memory card slot, accumulator charger connector and infrared port.

14. The device according to claim 13, wherein the case has a flat, visor-like shape.

15. The device according to claim 14, wherein the operating elements are formed as push-buttons arranged on the top surface of the visor-like case.

16. The device according to claim 15, wherein the bridging element comprises a raising member.

17. The device according to claim 16, wherein each of the image display blocks comprises a meniscus lens having asperical or aspherical operating surfaces and a mirorring coat on its convex side.

18. The device according to claim 17, wherein the light transmitting window of each image display block adjacent to the pupil comprises a correction lens with spherical or aspherical operating surfaces.
